(19) United States
(12) Patent Application Publication
(10) Pub. No.: US 2024/0331990 A1
(43) Pub. Date: Oct. 3, 2024

(54) GENERIC PEAK FINDER

(71) Applicant: DH Technologies Development Pte. Ltd., Singapore (SG)

(72) Inventors: Gordana IVOSEV, Etobicoke (CA); Eva DUCHOSLAV, Toronto (CA)

(73) Assignee: DH Technologies Development Pte. Ltd., Singapore (SG)

(21) Appl. No.: 18/293,148

(22) PCT Filed: Jul. 28, 2022
(86) PCT No.: PCT/IB2022/057022

§ 371 Date: Jan. 29, 2024

Related U.S. Application Data
(60) Provisional application No. 63/228,126, filed on Aug. 1, 2021.

(51) Int. Cl. H01J 49/00; G06V 10/52

(52) U.S. Cl. CPC H01J 49/0036; G06V 10/52

(57) ABSTRACT

A method for identifying peaks in a mass spectrum is provided. The method includes: accessing a mass spectrum (300), having an intensity signal, generated for analysis of a sample; performing a wavelet transformation on the intensity signal to generate a wavelet space representation (310) of the intensity signal; generating a scale-space-processing (SSP) response signal (412, 414, 416) from the wavelet space representation of the intensity signal, wherein the SSP response signal (412, 414, 416) represents the SSP response from the wavelet scale representation (310) at different wavelet scales for a particular m/z starting position (312, 314, 316); identifying a first wavelet scale for a first local maximum in the SSP response signal; based on the first wavelet scale, detect a first baseline intensity signal; subtracting the first baseline intensity signal from the intensity signal to generate a first adjusted intensity signal; and detecting one or more peaks in the first adjusted intensity signal.

### CROSS-REFERENCE TO RELATED APPLICATION

This application is being filed on Jul. 28, 2022, as a PCT International Patent Application that claims priority to and the benefit of U.S. Provisional Application No. 63/228,126 filed on Aug. 1, 2021, which application is hereby incorporated herein by reference in its entirety.

### BACKGROUND

Proper identification of peaks within a mass spectrum is a significant factor in the overall accuracy of the measurements and determinations that can be made from analysis of the mass spectrum. In some examples, however, peaks due to two different ions may be co-located at the same or substantially the same mass-to-charge (m/z) position. For example, an ion having twice the mass and twice the charge of another ion may contribute to a portion of an intensity signal at the same m/z position. The peaks formed by the different ions may be distinguishable by properties other than just m/z position, such as peak width or other peak characteristics.

### SUMMARY

In accordance with some embodiments, a method for identifying peaks in a mass spectrum is provided. The method includes: accessing a mass spectrum, having an intensity signal, generated for analysis of a sample; performing a wavelet transformation on the intensity signal to generate a wavelet space representation of the intensity signal; generating a scale-space-processing (SSP) response signal from the wavelet space representation of the intensity signal; identifying a first wavelet scale for a first local maximum in the SSP response signal; based on the first wavelet scale, detect a first baseline intensity signal; subtracting the first baseline intensity signal from the intensity signal to generate a first adjusted intensity signal; and detecting one or more peaks in the first adjusted intensity signal.

In accordance with some embodiments, a method for identifying peaks in a mass spectrum is provided. The method includes: accessing a mass spectrum having an intensity signal; transforming the intensity signal to a representation indicative of peak widths; based on the representation, detecting a plurality of dominant peak widths, including at least a first dominant peak width and a second dominant peak width; based on the first dominant peak width, detect a first baseline intensity signal; subtracting the first baseline intensity signal from the intensity signal to generate a first adjusted intensity signal; and detecting one or more peaks in the first adjusted intensity signal.

In accordance with some embodiments, a system for performing mass spectrometry is provided. The system includes: an ion source configured to ionize a sample to generate ions; a mass analyzer and a detector configured to detect the ions; one or more processors; and a memory storing instructions that, when executed by the one or more processors, cause the system to perform operations comprising: based on the detected ions, generating an intensity signal of a mass spectrum; transforming the intensity signal to a representation indicative of peak widths; based on the representation, detecting a plurality of dominant peak widths, including at least a first dominant peak width and a second dominant peak width; based on the first dominant peak width, detect a first baseline intensity signal; subtracting the first baseline intensity signal from the intensity signal to generate a first adjusted intensity signal; and detecting one or more peaks in the first adjusted intensity signal.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 an example mass spectrum.

FIG. 2 depicts an example system for performing mass spectrometry.

FIG. 3 depicts an example mass spectrum and a wavelet scale space plot corresponding to the mass spectrum.

FIG. 4 depicts an example scale space processing response plot, the wavelet scale space plot of FIG. 3, and the example spectrum of FIG. 3.

FIG. 5 depicts the example spectrum of FIGS. 3 and 4 with the original intensity signal and a baseline intensity signal.

FIG. 6 depicts an example spectrum showing isotopic peaks, a corresponding wavelet scale space plot, and a scale space processing response plot.

FIGS. 7A-7B depict an example method for identifying peaks according to the present technology.

FIG. 8 depicts another example method 800 for identifying peaks according to the present technology.

### DETAILED DESCRIPTION

As briefly discussed above, co-located or overlapping peaks in a mass spectrum are difficult to separately detect or identify. As one example, such overlapping peaks often occur in the analysis of bacteria or other small molecule analysis. Typical proteomics or small molecule mass spectral peak properties are well understood and modeled under assumptions of mass-analysis instrument type and acquisition setting. Most peak finders today utilize that prior knowledge to model algorithm parameters for optimal performance for a given spectra. Such optimization based on prior knowledge, however, may fail where there are co-located peaks that are unpredictable.

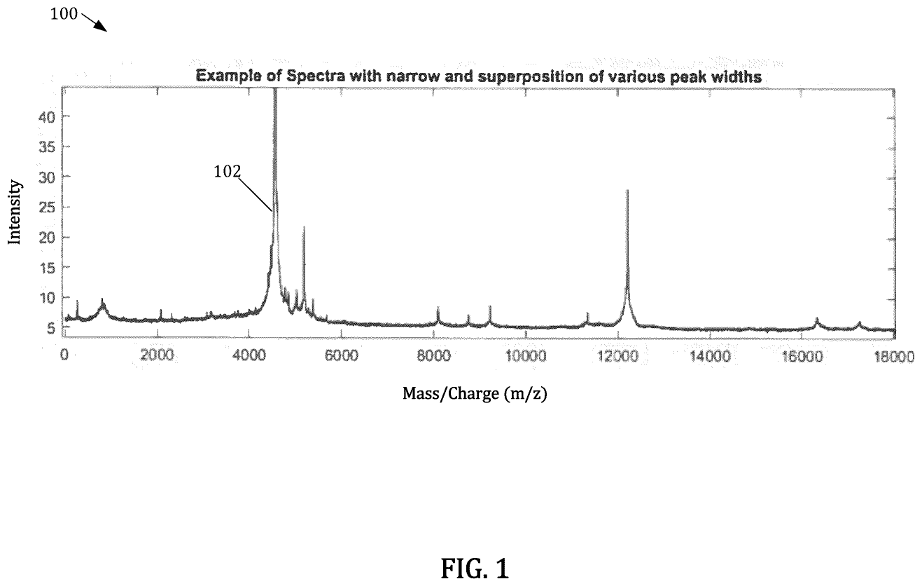

FIG. 1 depicts an example mass spectrum 100 with an intensity signal 102. The example mass spectrum is a typical mass spectrum from a matrix assisted laser desorption ionization-time of flight mass spectrometry (MALDI-TOF MS) of a bacterial culture acquired on a mass spectrometry system. The spectrum 100 includes peaks of a wide range of widths. The widths of the peaks are not dependent on the m/z position, and peaks of different sizes/widths are often superimposed or co-located. Co-located peaks in typical peptide sample mass spectra may have nearly identical or well predictable widths. However, in the example spectra 100, the pattern of superimposed peaks is not predictable, and the widths of any constituent peak may also not be predictable. Despite the peaks and peak widths not being predictable, it is still desirable to detect and characterize all peaks in the spectra in a robust, automated fashion.

Current peak finders are not capable of performing such techniques. For instance, some peak finders often do not have an ability to automatically adjust parameters for such varying peak widths. Other peak finders, like wavelet-based peak finders, may not recognize wide peaks under particular pattern of small, superimposed peaks, which may create inconsistent results. When properly detected, among other things, the detected peaks may be used to create a library of bacteria mass spectral fingerprints and subsequent bacterial identification and characterization. Therefore, it can be important to properly characterize all the peaks in the spectra. Typical peak finders do not provide such an appropriate characterization of peaks in these scenarios because these spectra do not meet typical assumptions regarding peak widths and noise.

Among other things, the present technology alleviates the above problems by providing for an iterative process that can automatically detect overlapping peaks of different widths. The technology recognizes the existence of dominant peak widths for a particular analytical experiment setting, and those dominant peak widths may be used to optimize workflow for peak detection and characterization. As an example, the dominant peak widths may be determined from a frequency domain, such as a wavelet space. For instance, a wavelet transformation may be performed on the intensity signal to generate a wavelet space representation, and a scale-space-processing (SSP) response signal may be generated. The dominant peak widths may then be determined from local maxima in the SSP response signal. Iterative peak detection may then be performed using parameters based on the determined dominant peak widths. Such iterative peak detection allows for multiple peaks being reported as individual entities at essentially the same or similar m/z position but with different widths. The identified peaks and peak characteristics may then be used for bacteria fingerprinting, among other uses.

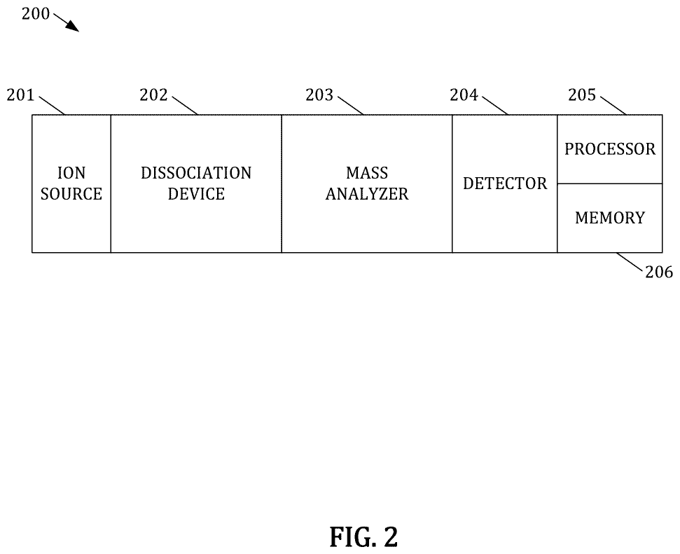

FIG. 2 depicts an example mass analysis system 200 for performing mass spectrometry techniques. In some examples, the system 200 may be a mass spectrometer. The example system 200 includes an ion source device 201, a dissociation device 202, a mass analyzer 203, a detector 204, and computing elements, such as a processor 205 and a memory 206. The ion source device 201 may be an matrix-assisted laser desorption/ionization source or electrospray ion source (ESI) device, as some examples. The ion source device 201 is shown as part of a mass spectrometer or may be a separate device. The dissociation device 202 may be an Electron-based dissociation (ExD) device or collision-induced dissociation (CID) device, for example. Electron-based dissociation (ExD), ultraviolet photodissociation (UVPD), infrared photodissociation (IRMPD) and collision-induced dissociation (CID) are often used as fragmentation techniques for tandem mass spectrometry (MS/MS). ExD can include, but is not limited to, electron capture dissociation (ECD) or electron transfer dissociation (ETD). CID is the most conventional technique for dissociation in tandem mass spectrometers. As described above, in top-down and middle-down proteomics, an intact or digested protein is ionized and subjected to tandem mass spectrometry. ECD, for example, is a dissociation technique that dissociates peptide and protein backbones preferentially.

The mass analyzer 203 can be any type of mass analyzer used for a for performing mass analysis, such as triple quadrupole system, an orbitrap system, a time-of-flight (TOF) mass spectrometer, or a Fourier-transform ion cyclotron resonance mass analyzer. The detector 204 may be an appropriate detector for detection ions and generating the signals discussed herein. For example, the detector 204 may include an electron multiplier detector that may include analog-to-digital conversion (ADC) circuitry. The detector 204 may also be an image charge induced detector. An ADC detector detects impacts of ions on the detector to generate a count or intensity of ions. The image-detector an image-charge detector detects oscillations of the ions in the mass analyzer to generate a count or intensity of the ions.

The computing elements of the system 200, such as the processor 205 and memory 206, may be included in the mass spectrometer itself, located adjacent to the mass spectrometer, or be located remotely from the mass spectrometer. In general, the computing elements of the system may be in electronic communication with the detector 204 such that the computing elements are able to receive the signals generated from the detector 204. The processor 205 may include multiple processors and may include any type of suitable processing components for processing the signals and generating the results discussed herein. Depending on the exact configuration, memory 206 (storing, among other things, mass analysis programs and instructions to perform the operations disclosed herein) can be volatile (such as RAM), non-volatile (such as ROM, flash memory, etc.), or some combination of the two. Other computing elements may also be included in the system 200. For instance, the system 200 may include storage devices (removable and/or non-removable) including, but not limited to, solid-state devices, magnetic or optical disks, or tape. The system 200 may also have input device(s) such as touch screens, keyboard, mouse, pen, voice input, etc., and/or output device(s) such as a display, speakers, printer, etc. One or more communication connections, such as local-area network (LAN), wide-area network (WAN), point-to-point, Bluetooth, RF, etc., may also be incorporated into the system 200.

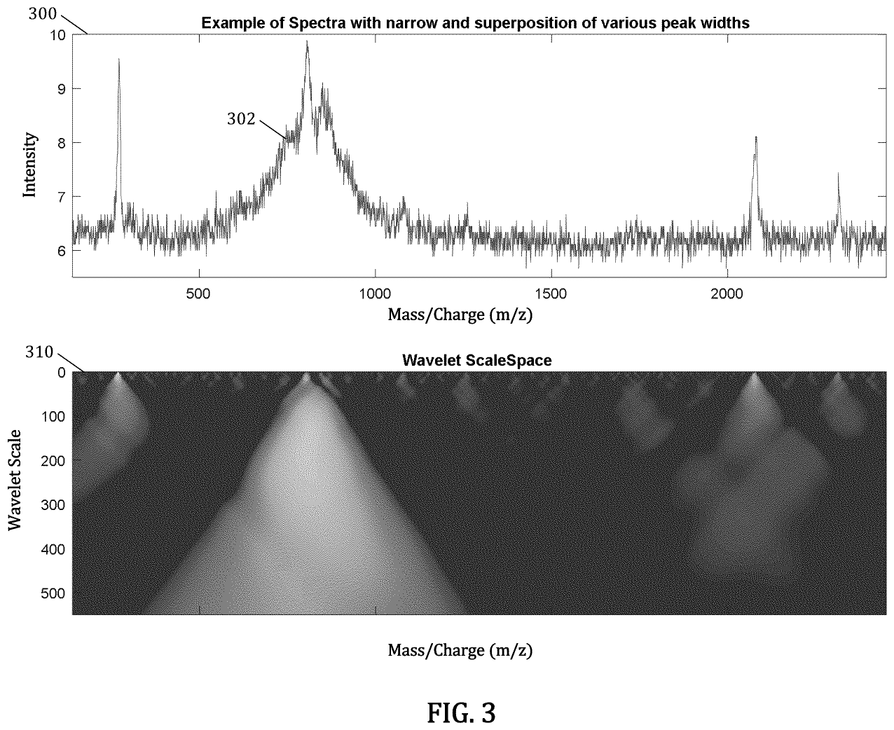

FIG. 3 depicts an example mass spectrum 300 and a wavelet scale space plot 310 corresponding to the mass spectrum 300. The mass spectrum 300 is a portion of the mass spectrum 100 in FIG. 1 and discussed above. The example mass spectrum 300 has an x-axis of m/z and y-axis of intensity, which may be based on count of detected ions. An intensity signal 302 of the mass spectrum is generated based on ions detected by a mass spectrometry system. The example spectrum 300 includes a plurality of peaks having various widths that are superimposed with one another.

The intensity signal 302 may be converted to a frequency-based domain through various signal processing methods. As one example, the intensity signal 302 may be converted to a wavelet scale space through the use of a wavelet transform, such as a continuous wavelet transform. An example wavelet scale space plot 310 is depicted in FIG. 3 as aligned with the spectrum 300. Similar to the spectrum 300, the wavelet scale space plot 310 has an x-axis of m/z. The wavelet scale space plot 300 has a y-axis of wavelet scale. The wavelet scale increases as the plot 310 moves downward. A larger wavelet scale corresponds to a lower frequency or a wider wavelet. The strength of the wavelet response is represented by color in the in the wavelet scale space plot 310. Accordingly, a strong response at a lower wavelet scale is indicative of a narrow peak, and a strong response at a greater wavelet scale is indicative of a wider peak. Thus, the present technology may be used to determine dominant peak widths at various m/z positions from an analysis of the wavelet scale space and the corresponding response strengths.

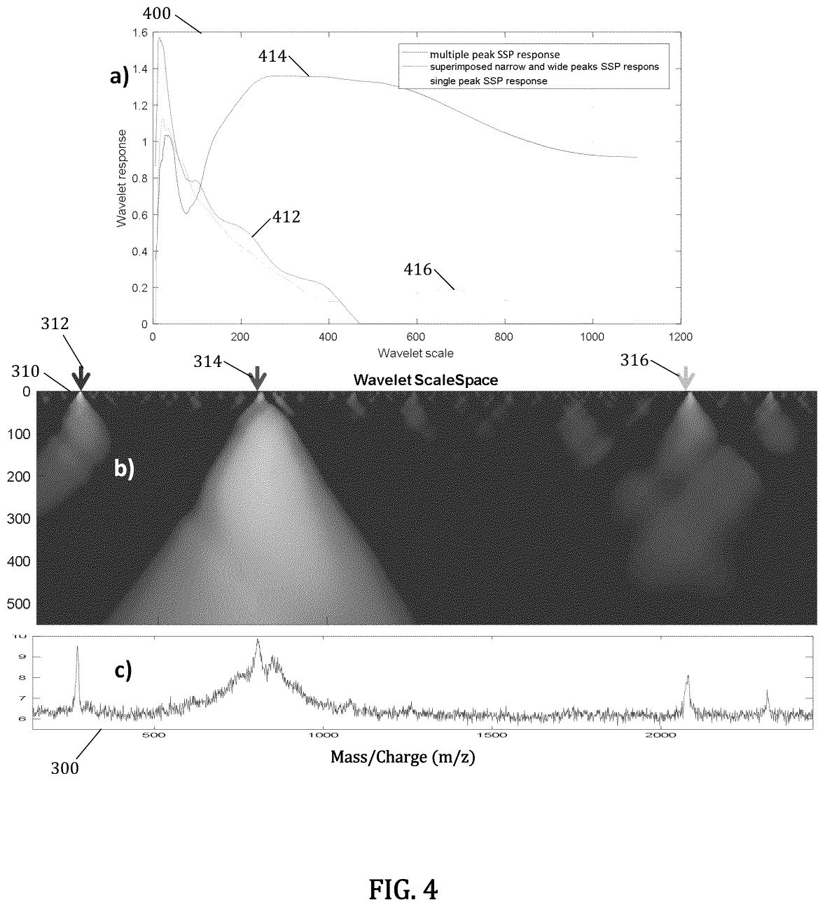

FIG. 4 depicts an example scale space processing (SSP) response plot 400, the wavelet scale space plot 310 of FIG. 3, and the example spectrum 300 of FIG. 3. The SSP response plot 400 includes a plurality of SSP response signals 412-416. The SSP response plot 400 has an x-axis of wavelet scale, and a y-axis of wavelet response. Thus, the respective SSP response signals 412-416 represent the SSP response from the wavelet scale space plot 310 at different wavelet scales for a particular m/z starting position.

More specifically, the SSP response plot 400 includes a first SSP response signal 412, a second SSP response signal 414, and a third SSP response signal 416. The first SSP response signal 412 is generated from a starting m/z position of about 250, the second SSP response signal 414 is generated from a starting m/z position of about 700, and the third SSP response signal 416 is generated from a starting m/z position of about 2200. Each respective starting position is indicated by an arrow above the wavelet scale space plot 310. For example, the starting position of the first SSP response signal 412 is indicated by the first arrow 312, the starting position of the second SSP response signal 414 is indicated by the second arrow 314, and the starting position of the third SSP response signal 416 is indicated by the third arrow 316. In the example of FIG. 4, the particular m/z starting positions are particular local maxima position at the lowest wavelet scale. It should be noted that in other implementations, the particular m/z starting positions may be particular local maxima positions at the highest wavelet scale. Those SSP response signals (e.g., 412, 414, 416) are generated by connecting local maxima within some small neighborhood of m/z value of the previous scale local maxima position.

The starting positions may be set manually or determined automatically. For instance, a plurality of peaks may be identified through manual input, and those manual identifications may be used as starting points for generating respective SSP response signals. The starting positions may also be identified by identifying wavelet response values in lower wavelet scales that exceed a threshold. In other examples, starting points may be set to regular m/z intervals, such as 0.1, such that SSP response signals are generated for many m/z positions across the spectrum.

Each of the response signals may be generated by analyzing the wavelet response strength by traversing the wavelet scale space plot 310 from the respective starting position (e.g., an m/z position and the minimum wavelet size used for the wavelet transformation). The SSP response signal may be generated by traversing the wavelet scale space to progressively larger wavelet sizes by moving to the next nearest maximum response value within a neighborhood of the prior point. The next nearest maximum response may be at the same m/z position as the starting position or a different m/z position within a tolerance. At each point in the traversal, the wavelet response strength is recorded and used to form the respective SSP response signal.

One characteristic of the SSP response signal that is of interest is the path length of the SSP response signal. The path length of the SSP response signal is a length of the SSP response signal before reaching a zero (or another minimum threshold) wavelet response. The path length may be measure in the wavelet scale. For example, the SSP signal 412 has a path length of roughly 450, while the SSP signal 416 has a path length of roughly 1000. The path length may be used as an indicator as to how likely a peak is present instead of merely noise in the intensity signal. For example, noise generally has a short path length whereas real peaks generally have a longer path length. Accordingly, path length being greater than a path length threshold may be an indication of real peak rather than noise.

Dominant peak widths at or near an m/z position may be determined from the respective SSP response signals. For instance, the dominant peak widths may be determined from the local maxima of the respective local maxima of the SSP response signal. As an example, the second SSP response signal 414 has a first local maximum at a wavelet scale position of roughly 50 and a second local maximum at roughly 210. Those identified local maxima are indicative of dominant peak widths for peaks near the m/z starting point of about 700. In other words, peaks having widths corresponding to wavelet scale of about 50 and 210 may be present at an m/z position of 700 in the mass spectrum 300. This dominant peak information may be used to optimize peak finding algorithms and generate adjusted signals from which peaks can be detected and quantified, as discussed further below. The dominant peak information may also be used to quantitatively decompose overlapping mass spectral peaks of different sizes. It should be noted that the process described with reference to FIG. 4 may be iterative, and the process may stop iterating when certain noise is reached.

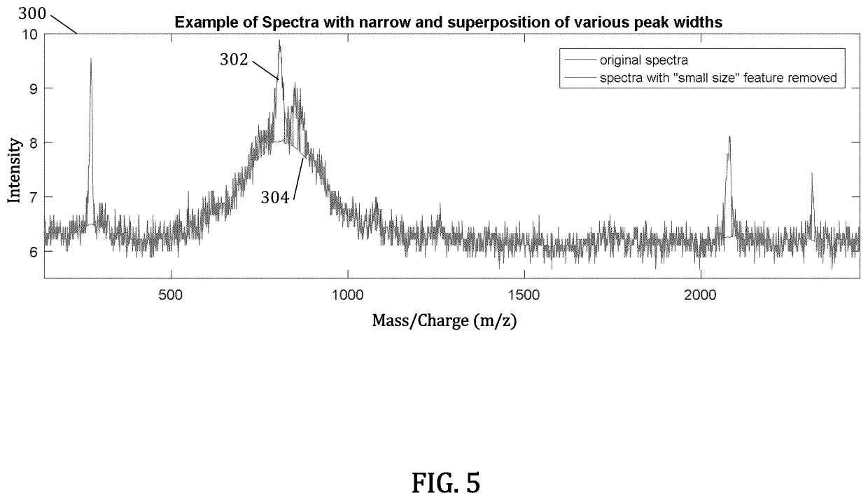

FIG. 5 depicts the example spectrum 300 of FIGS. 3 and 4 with the original intensity signal 302 and a baseline intensity signal 304. Based on the identified dominant peak widths discussed above, baseline intensity signals may be detected within the original intensity signal. Baseline intensity signals may be generated or detected iteratively based on the number of local maxima that are detected in a respective SSP response signal. The spectrum 300 in FIG. 5 depicts one step of this iterative process. It should be noted that this is simply one of multiple ways of decomposing quantitatively overlapping mass spectral peaks of different sizes.

In the spectrum 300, the original intensity signal 302 is depicted as well as a first baseline intensity signal 304 that is based on the first dominant peak width determined from the second SSP response signal 414. For instance, as discussed above, the first local maxima of the SSP response signal had a wavelet scale value about 50. The baseline intensity signal 304 is the original intensity signal 302 with only features corresponding to a wavelet scale greater than 50 (e.g., wider features). In other words, the baseline intensity signal 304 is equivalent to the original intensity signal 302 with the small-scale features (e.g., features corresponding to a wavelet scale of 50 or smaller) removed.

With the baseline intensity signal 304 established, an adjusted intensity signal may be generated by subtracting the baseline intensity signal 304 from the original intensity signal 302 to generate an adjusted intensity signal. One or more peaks may then be identified or detecting in the adjusted intensity signal. Detection of the peaks in the adjusted intensity signal may be accomplished through a variety of methods. As an example, detecting the peaks in the adjusted intensity signal may be implement by finding local maxima in the adjusted intensity signal. For instance, a wavelet transformation may be performed on the adjusted intensity signal to generate a wavelet scale space representation of the adjusted intensity signal. Peaks of the adjusted intensity signal may then be identified through the use of the wavelet scale space representation, such as through an analysis of a SSP response signal from the newly generated wavelet scale space representation. It is very important to decompose overlapping mass spectral peaks of different sizes. In mass spectrometry, feature of interest is represented is represented by multiple peaks, all having practically identical scale (size, width) or predictable size with respect to particular m/z position. Interpreting those features and correctly finding the charge state are much easier if the spectrum is simple (i.e., no overlap of those features or relevant regions). The techniques disclosed here can reduce complexity by removing unrelated intensities of spectral features of distinct sizes.

Alternatively or additionally, first dominant peak width (e.g., wavelet scale of 50 in this example), may be determined by using the first dominant peak width as an optimal scale for a peak finding algorithm. For instance, parameters of the peak finding algorithm may be tuned based on the first dominant peak width such that the peak finding algorithm targets peaks having a width of or near the first dominant peak width. The tradeoff between performing another wavelet transform on the adjusted intensity signal or not is a difference between speed, sensitivity, and a specificity. For example, performing another wavelet transform may result in additional processing time, but the sensitivity and/or specificity may increase.

The peaks identified in the adjusted intensity signal may then be added to a peak list with their corresponding peak characteristics. The peak characteristics may include characteristics, such a peak height, peak width, peak area, the optimum scale used to identify the peak, an SSP response path length, the SSP response value for the peak width (e.g., the SSP response value at the first local maximum), and/or a signal-to-noise ratio.

The above process may then be repeated using the baseline intensity signal 304 as the signal of interest (e.g., treating the baseline intensity signal 304 as if it were the original intensity signal 302 for the next iteration). Continuing with the example above, a second baseline intensity signal may be detected or generated based on the second local maximum identified in the second SSP signal 414. In the present example, the second baseline signal may be equal to the first baseline signal 304 with only features corresponding to a wavelet scale greater than 210 (e.g., even wider features than the first baseline signal 304). In other words, the second baseline signal may be equivalent to the baseline intensity signal 304 with the features having a scale less than the second dominant peak width (e.g., wavelet scale of 210) removed.

A second adjusted intensity signal may then be generated by subtracting the second baseline intensity signal from the first baseline intensity signal. That second adjusted intensity signal may then be analyzed to detect or identify peaks in the second adjusted intensity signal. The detection of peaks may be performed in a similar manner as discussed above with respect to the detection of peaks from the first adjusted intensity signal but using the second dominant peak width instead of the first dominant peak width. The peaks identified in the second adjusted intensity signal may then be added to the peak list with their corresponding peak properties. The process may iteratively continue in examples where additional dominant peak widths are identified in the SSP response signal. Any additionally identified peaks from further iterations of adjusted intensity signals may also then be added to the peak list.

The peaks in the peak list may then be used to identify compounds within the analyzed sample and/or the amount of such compounds in the sample (e.g., a quantity of an analyte). For instance, the peaks in the peak list may be compared to peak lists in a library of peak patterns. Where the peaks in the peak list match a peak pattern in the library, a compound may be identified based on the match. One example of such a matching is in bacteria fingerprinting using mass spectrometry. For example, the peak listing may effectively serve as a fingerprint (e.g., unique pattern) for different types of bacteria. Once that fingerprint or pattern is identified, the bacteria in the sample can similarly be identified.

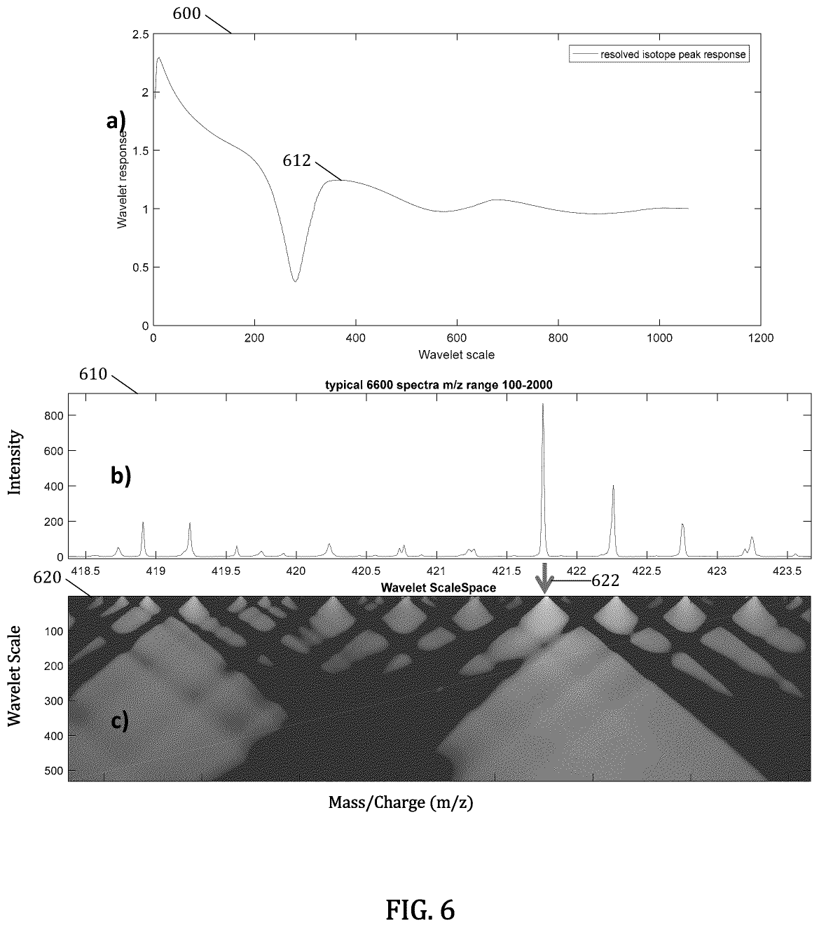

FIG. 6 depicts an example spectrum 610 showing isotopic peaks, a corresponding wavelet scale space plot 620, and a scale space processing response plot 600. The iterative process described above helps identify co-located peaks as discussed above, but it is also useful in other scenarios as well. For example, where a spectrum includes evenly spaced peaks, such as isotopic peaks shown in the spectrum 610, a strong wavelet response may appear for each of the narrow peaks (e.g., at a small wavelet scale), and a relatively strong wavelet response may appear at a larger scale corresponding to the combination of the isotopic peaks. For example, the combination of the isotopic peaks looks roughly like a large Gaussian curve across the m/z space having a much larger width than any individual peak.

Such an example is seen in the wavelet scale space plot 620 and SSP response plot 600. For an SSP response signal 612 with a starting point 622 at 421.75 on the m/z range, local maxima are seen at various wavelet scales. By performing the iterative process described above for each of the local maxima, it will be revealed that there is no extra wide peak corresponding to the combination of the isotope peak. Accordingly, there is yet another benefit to using the present technology.

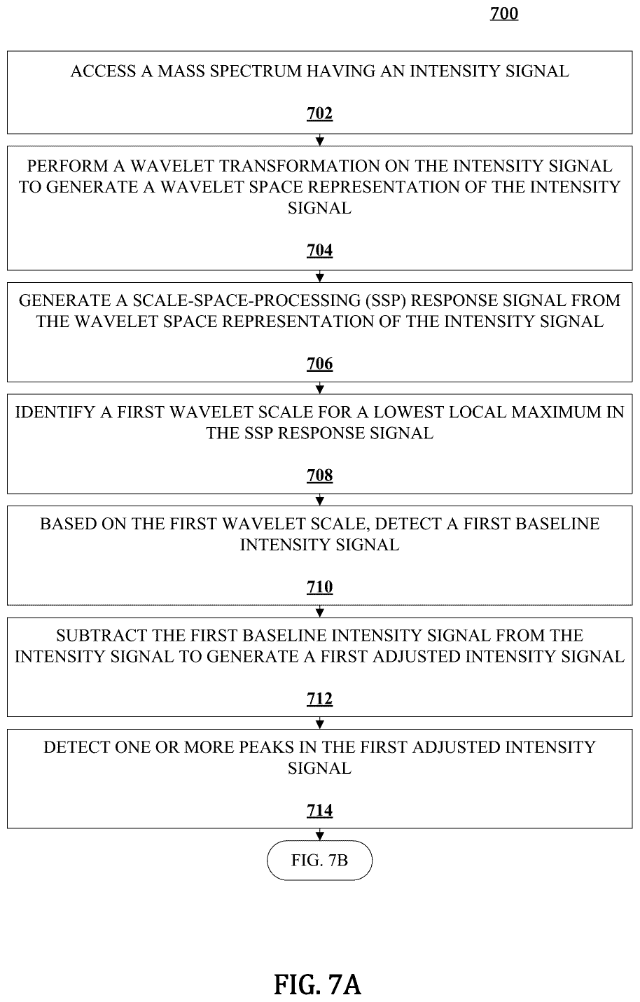

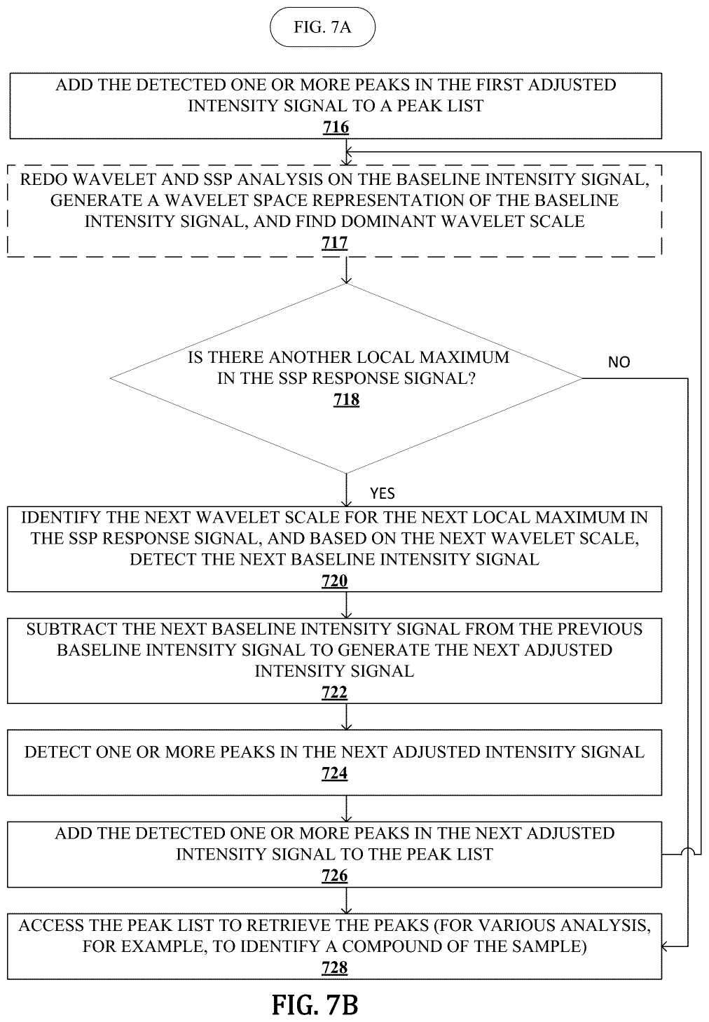

FIGS. 7A-7B depict an example method 700 for identifying peaks according to the present technology. The operations of method 700 may be performed by one or more components of the systems described herein, such as by one or more processors. At operation 702, a mass spectrum is accessed. The mass spectrum is for a sample analyzed using a mass spectrometry system that generated the mass spectrum. The mass spectrum may be accessed from storage in memory. The mass spectrum may also be generated by a mass spectrometry system as part of operation 702. The mass spectrum includes an intensity signal such as the intensity signals discussed above. The intensity signal of the original mass spectrum accessed in operation 702 may be referred to as the original intensity signal.

At operation 704, a wavelet transformation is performed on the intensity signal to generate a wavelet space representation of the intensity signal. The wavelet transformation may be a continuous wavelet transformation. At operation 706, a scale space processing (SSP) response signal is generated. The SSP response signal represents the strength of the scale space response at different wavelet scales for m/z positions, as discussed above. In some examples, more than one SSP response signal may be generated. For instance, SSP response signals may be generated from different m/z starting positions.

At operation 708, a first wavelet scale for a first local maximum in the SSP response signal is identified. For example, the SSP response signal may be analyzed to determine the local maxima of the SSP response signal. The first local maximum may be the local maximum having the smallest wavelet scale. The first wavelet scale is the wavelet scale of the SSP response signal at the first local maximum.

Based on the first wavelet scale identified in operation 708, a first baseline intensity signal is identified in operation 710. The first baseline intensity signal may be the intensity signal with only features corresponding to a wavelet size greater than the first wavelet scale. In other words, the first baseline intensity signal may be equivalent to the original intensity signal with features having a scale smaller than the first wavelet scale removed.

At operation 712, a first adjusted intensity signal is generated based on the original intensity signal and the baseline intensity signal. The first adjusted intensity signal may be generated by subtracting the first baseline intensity signal from the original intensity signal.

At operation 714, one or more peaks in the first adjusted intensity signal are detected. Detection of the peaks in the first adjusted intensity signal may be accomplished through a variety of methods. As an example, the first adjusted intensity signal may be converted to a frequency domain representation, and the peaks may be identified at least in part from the frequency domain representation. For instance, a wavelet transformation may be performed on the first adjusted intensity signal to generate a wavelet scale space representation of the first adjusted intensity signal. Peaks of the first adjusted intensity signal may then be identified through the use of the wavelet scale space representation, such as through an analysis of a SSP response signal from the newly generated wavelet scale space representation. Alternatively or additionally, the first wavelet scale may be used as an optimal scale for a peak finding algorithm. For instance, parameters of the peak finding algorithm may be tuned based on the first wavelet scale such that the peak finding algorithm targets peaks having a width corresponding to the first wavelet scale.

At operation 716, the one or more peaks detected in operation 714 are added to a peak list. The peaks may be added to the peak list with corresponding characteristics. The peak characteristics may include characteristics, such a peak height, peak width, peak area, the optimum scale used to identify the peak, an SSP response path length, the SSP response value for the peak width (e.g., the SSP response value at the first local maximum), and/or a signal-to-noise ratio.

Optionally at operation 717, the wavelet and SSP analysis on the baseline intensity signal are redone, and a wavelet space representation of the baseline intensity signal is generated, and a dominant wavelet scale is found. It should be noted that another option is to find all dominant wavelet scales from the SSP response signal once and iterate for all of them.

At operation 718, it is determined whether another local maximum (i.e., the next local maximum with respect to the previous local maximum) in the SSP response signal generated in operation 706 exists. For example, as discussed above, the SSP response signal may be analyzed to determine the local maxima of the SSP response signal. In one example, the next local maximum is the second local maximum that is the local maximum having the second-smallest wavelet scale. If another local maximum in the SSP response signal does not exist, the method 700 proceeds to operation 728. If there is another local maximum in the SSP response signal, the method 700 proceeds to operation 720.

In some examples, the next wavelet scale may be determined by performing a wavelet transformation on the previous background intensity signal to generate a wavelet space representation of the previous background intensity signal. Another (SSP) response signal may then be generated from the wavelet space representation of the previous background intensity signal. A local maximum of that newly generated SSP response signal may then be used determined the next wavelet scale. By performing the wavelet transformation again on the previous background intensity signal, a potentially more accurate identification of the next dominant peak width may be achieved because the process of removing the small features to generate the previous background intensity signal may have also removed noise.

At operation 720, the next wavelet scale for the next local maximum in the SSP response signal is identified, and based on the next wavelet scale, the next baseline intensity signal is detected or generated. The next baseline intensity signal may be the previous baseline intensity signal with only features corresponding to a wavelet size greater than the next wavelet scale. In other words, the next baseline intensity signal may be equivalent to the previous baseline intensity signal with features having a scale smaller than the next wavelet scale removed.

At operation 722, the next adjusted intensity signal is generated based on the previous baseline intensity signal and the next baseline intensity signal. The next adjusted intensity signal may be generated by subtracting the next baseline intensity signal from the previous baseline intensity signal.

At operation 724, one or more peaks in the next adjusted intensity signal may be detected. The one or more peaks may be identified in similar manners as the one or peaks that were detected in operation 714. For instance, the next adjusted intensity signal may be converted to a frequency domain representation, and the peaks may be identified at least in part from the frequency domain representation. For instance, a wavelet transformation may be performed on the next adjusted intensity signal to generate a wavelet scale space representation of the next adjusted intensity signal. Peaks of the next adjusted intensity signal may then be identified through the use of the wavelet scale space representation, such as through an analysis of a SSP response signal from the newly generated wavelet scale space representation. Alternatively or additionally, the next wavelet scale may be used as an optimal scale for a peak finding algorithm. For instance, parameters of the peak finding algorithm may be tuned based on the next wavelet scale such that the peak finding algorithm targets peaks having a width corresponding to the next wavelet scale.

At operation 726, the detected one or more peaks in the next adjusted intensity signal are added to the peak list. For instance, the peaks detected in operation 724 may be added to the same peak list that used in operation 716. The peaks may be added to the peak list with corresponding characteristics.

At operation 728, the peak list is accessed to retrieve the peaks for various analysis. In one example, the peak list is accessed to retrieve the peaks to identify a compound of the sample for which the mass spectrum was generated, based on the peaks and/or the peak characteristics in the peak list. For instance, the peaks in the peak list may be compared to peak lists in a library of peak patterns. Where the peaks in the peak list match a peak pattern in the library, a compound may be identified based on the match. One example of such a matching is in bacteria fingerprinting using mass spectrometry. For example, the peak listing may effectively serve as a fingerprint (e.g., unique pattern) for different types of bacteria. Once that fingerprint or pattern is identified, the bacteria in the sample can similarly be identified. Again, it should be noted that the example method 700 illustrated in FIG. 7A and FIG. 7B is iterative. The example method 700 stops repeating itself until there is no more local maximum in the SSP response signal (checked at operation 718) and the example method 700 eventually ends at operation 728.

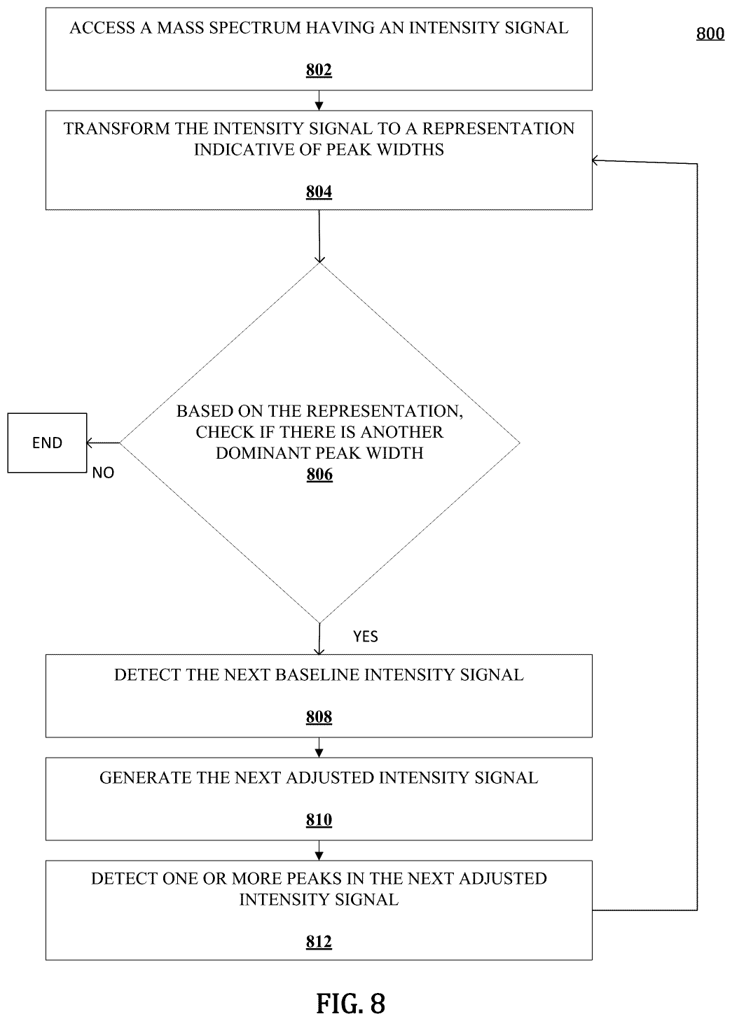

FIG. 8 depicts another example method 800 for identifying peaks according to the present technology. The operations of method 800 may be performed by one or more components of the systems described herein, such as by one or more processors. At operation 802, a mass spectrum, including an intensity signal, for an analyzed sample is accessed. The mass spectrum may be accessed or generated as discussed above. At operation 804, the intensity signal is transformed to a representation indicative of peak widths in the mass spectrum. For example, the intensity signal may be transformed from its spatial signal domain space (e.g., the original m/z domain space) to a frequency domain. The transformation may be accomplished through Fourier-based transforms, wavelet transforms or other similar transforms. As some example, the intensity signal may be transformed via a wavelet transformation to generate a wavelet space representation of the intensity signal.

At operation 806, based on the representation generated in operation 804, it is checked whether there is another dominant peak width. The plurality of dominant peak widths may be identified by dominant response signals in the representation. In an example where the representation is a wavelet scale space representation, detecting the dominant peaks may include generating a scale-space-processing (SSP) response signal from the wavelet space representation of the intensity signal. In one example, the first local maximum in the SSP response signal corresponding to the first dominant peak width may then be identified, and the next (i.e., the second in this example) local maximum in the SSP response signal corresponding to the next (i.e., the second in this example) dominant peak width may be identified. If another dominant peak width does not exist, the method 800 ends. If there is another dominant peak width, the method 800 proceeds to operation 808.

At operation 808, based on the next dominant peak width, the next baseline intensity signal may be generated. The next baseline intensity signal may be the original intensity signal with only features corresponding to a peak width size greater than the next dominant peak width. In other words, the next baseline intensity signal may be equivalent to the original intensity signal with features having a scale smaller than the next dominant peak width removed.

At operation 810, the next adjusted intensity signal is generated based on the original intensity signal and the baseline intensity signal. The next adjusted intensity signal may be generated by subtracting the next baseline intensity signal from the original intensity signal.

At operation 812, one or more peaks in the next adjusted intensity signal are detected. Detection of the peaks in the next adjusted intensity signal may be accomplished through a variety of methods. As an example, the next adjusted intensity signal may be converted to a frequency domain representation, and the peaks may be identified at least in part from the frequency domain representation. For instance, a wavelet transformation may be performed on the next adjusted intensity signal to generate a wavelet scale space representation of the next adjusted intensity signal. Peaks of the next adjusted intensity signal may then be identified through the use of the wavelet scale space representation, such as through an analysis of a SSP response signal from the newly generated wavelet scale space representation. Alternatively or additionally, the next dominant peak width may be used as an optimal scale for a peak finding algorithm. For instance, parameters of the peak finding algorithm may be tuned based on the next dominant peak width such that the peak finding algorithm targets peaks having a width corresponding to the next dominant peak width. The detected peaks and their corresponding peak characteristics may then be added to a peak list. Then the operation 812 proceeds to operation 804, and the next baseline intensity signal is used as the intensity signal in operation 804 to transform it to a representation indicative of peak widths. The method 800 iterates until the decision at operation 806 is “NO”. In other words, the method 800 ends when there is no more dominant peak width.

A compound of the sample for which the mass spectrum was generated may then be identified based on the peaks and/or the peak characteristics in the peak list. For instance, the peaks in the peak list may be compared to peak lists in a library of peak patterns. Where the peaks in the peak list match a peak pattern in the library, a compound may be identified based on the match. One example of such a matching is in bacteria fingerprinting using mass spectrometry. For example, the peak listing may effectively serve as a fingerprint (e.g., unique pattern) for different types of bacteria. Once that fingerprint or pattern is identified, the bacteria in the sample can similarly be identified.

Those skilled in the art will recognize that the methods and systems of the present disclosure may be implemented in many manners and as such are not to be limited by the foregoing aspects and examples. In other words, functional elements being performed by a single component, or multiple components, in various combinations of hardware and software or firmware, and individual functions, can be distributed among software applications at either the client or server level or both. In this regard, any number of the features of the different aspects described herein may be combined into single or multiple aspects, and alternate aspects having fewer than or more than all of the features herein described are possible.

Functionality may also be, in whole or in part, distributed among multiple components, in manners now known or to become known. Thus, a myriad of software/hardware/firmware combinations are possible in achieving the functions, features, interfaces, and preferences described herein. Moreover, the scope of the present disclosure covers various manners for carrying out the described features and functions and interfaces, and those variations and modifications that may be made to the hardware or software firmware components described herein as would be understood by those skilled in the art now and hereafter. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

Further, as used herein and in the claims, the phrase “at least one of element A, element B, or element C” is intended to convey any of: element A, element B, element C, elements A and B, elements A and C, elements B and C, and elements A, B, and C. In addition, one having skill in the art will understand the degree to which terms such as “about” or “substantially” convey in light of the measurement techniques utilized herein. To the extent such terms may not be clearly defined or understood by one having skill in the art, the term “about” shall mean plus or minus ten percent.

Numerous other changes may be made which will readily suggest themselves to those skilled in the art and which are encompassed in the spirit of the disclosure and as defined in the appended claims. While various aspects have been described for purposes of this disclosure, various changes and modifications may be made which are well within the scope of the disclosure. Numerous other changes may be made which will readily suggest themselves to those skilled in the art and which are encompassed in the spirit of the disclosure and as defined in the claims.

What is claimed is:

1. A method for identifying peaks in a mass spectrum, the method comprising:
accessing a mass spectrum, having an intensity signal, generated for analysis of a sample;
performing a wavelet transformation, on the intensity signal to generate a wavelet space representation of the intensity signal;
generating a scale-space-processing (SSP) response signal from the wavelet space representation of the intensity signal;
identifying a first wavelet scale for a first local maximum in the SSP response signal;
based on the first wavelet scale, detect a first baseline intensity signal;
subtracting the first baseline intensity signal from the intensity signal to generate a first adjusted intensity signal; and
detecting one or more peaks in the first adjusted intensity signal.

2. The method of claim 1, further comprising:
identifying a second wavelet scale for a second local maximum in the SSP response signal;
based on the second wavelet scale, detect a second baseline intensity signal;
subtracting the second baseline intensity signal from the first baseline intensity signal to generate a second adjusted intensity signal; and
detecting one or more peaks in the second adjusted intensity signal.

3. The method of claim 1, wherein detecting the one or more peaks in the first adjusted intensity signal includes performing a wavelet transformation on the first adjusted intensity signal.

4. The method of claim 1, wherein detecting the one or more peaks in the first adjusted intensity signal includes using the first wavelet scale as an optimal scale for a peak-finding algorithm.

5. The method of claim 2, further comprising:
adding the detected one or more peaks in the first adjusted intensity signal to a peak list; and
adding the detected one or more peaks in the second adjusted intensity signal to the peak list.

6. The method of claim 5, further comprising including characteristics of the one or more detected peaks in the peak list, wherein the characteristics include at least one of optimum scale, SSP response path length, SSP response value, or a signal-to-noise ratio.

7. The method of claim 5, further comprising identifying a compound of the sample based on the peaks in the peak list.

8. A method for identifying peaks in a mass spectrum, the method comprising:
accessing a mass spectrum having an intensity signal;
transforming the intensity signal to a representation indicative of peak widths;
based on the representation, detecting a plurality of dominant peak widths, including at least a first dominant peak width and a second dominant peak width;
based on the first dominant peak width, detect a first baseline intensity signal;
subtracting the first baseline intensity signal from the intensity signal to generate a first adjusted intensity signal; and
detecting one or more peaks in the first adjusted intensity signal.

9. The method of claim 8, further comprising:
based on the second dominant peak width, detect a second baseline intensity signal;
subtracting the second baseline intensity signal from the first baseline intensity signal to generate a second adjusted intensity signal; and
detecting one or more peaks in the second adjusted intensity signal.

10. The method of claim 8, wherein detecting the one or more peaks in the first adjusted intensity signal includes performing a wavelet transformation on the first adjusted intensity signal.

11. The method of claim 8, wherein detecting the one or more peaks in the first adjusted intensity signal includes using the first dominant peak width as an optimal scale for a peak-finding algorithm.

12. The method of claim 8, wherein transforming the intensity signal to a representation indicative of peak widths includes performing a wavelet transformation on the intensity signal to generate a wavelet space representation of the intensity signal.

13. The method of claim 12, wherein detecting the plurality of dominant peak widths includes:
generating a scale-space-processing (SSP) response signal from the wavelet space representation of the intensity signal;
identifying a first local maximum in the SSP response signal corresponding to the first dominant peak width; and
identifying a second local maximum in the SSP response signal corresponding to the second dominant peak width.

14. The method of claim 8, further comprising identifying a compound in a sample based on at least one of the detected one or more peaks of the first adjusted intensity signal or the one or more peaks of the second adjusted intensity signal.

15. A system for performing mass spectrometry, the system comprising:
an ion source configured to ionize a sample to generate ions;
a mass analyzer and a detector configured to detect the ions;
one or more processors; and
a memory storing instructions that, when executed by the one or more processors, cause the system to perform operations comprising:
based on the detected ions, generating an intensity signal of a mass spectrum;
transforming the intensity signal to a representation indicative of peak widths;
based on the representation, detecting a plurality of dominant peak widths, including at least a first dominant peak width and a second dominant peak width;
based on the first dominant peak width, detect a first baseline intensity signal;
subtracting the first baseline intensity signal from the intensity signal to generate a first adjusted intensity signal; and
detecting one or more peaks in the first adjusted intensity signal.

16. The system of claim 15, wherein the operations further comprise:
based on the second dominant peak width, detect a second baseline intensity signal;
subtracting the second baseline intensity signal from the first baseline intensity signal to generate a second adjusted intensity signal; and
detecting one or more peaks in the second adjusted intensity signal.

17. The system of claim 15, wherein transforming the intensity signal to a representation indicative of peak widths includes performing a wavelet transformation on the intensity signal to generate a wavelet space representation of the intensity signal.

18. The system of claim 17, wherein detecting the plurality of dominant peak widths includes:
generating a scale-space-processing (SSP) response signal from the wavelet space representation of the intensity signal;
identifying a first local maximum in the SSP response signal corresponding to the first dominant peak width; and
identifying a second local maximum in the SSP response signal corresponding to the second dominant peak width.

19. The system of claim 15, wherein detecting the one or more peaks in the first adjusted intensity signal includes performing a wavelet transformation on the first adjusted intensity signal.

20. The system of claim 15, wherein detecting the one or more peaks in the first adjusted intensity signal includes using the first dominant peak width as an optimal scale for a peak-finding algorithm.
